(19) United States
(12) Patent Application Publication
(10) Pub. No.: US 2021/0337780 A1
(43) Pub. Date: Nov. 4, 2021

(54) REALISTIC COLLAPSIBLE TURKEY TAIL FAN

(71) Applicant: Plano Molding Company, LLC, Plano, IL (US)

(72) Inventors: Timothy S. MAKOS, Grafton, WI (US); Fred ZINK, Port Clinton, OH (US)

(21) Appl. No.: 17/241,552

(22) Filed: Apr. 27, 2021

Related U.S. Application Data
(60) Provisional application No. 63/017,299, filed on Apr. 29, 2020.

(51) Int. Cl. A01M 31/06

(52) U.S. Cl. CPC A01M 31/06

(57) ABSTRACT

A tail fan device is disclosed that can be included with or attached to a decoy device such as a Tom Turkey decoy, or used by itself as a collapsible turkey fan device. The tail fan device can be constructed to be easily removable from or attachable to the decoy device. The tail fan device can be constructed to be collapsible to require less storage space or to allow easier transport.

### CROSS REFERENCE TO PRIOR APPLICATION

This application claims priority to and the benefit thereof from the U.S. Provisional Application No. 63/017,299, filed Apr. 29, 2020, titled “Realistic Collapsible Turkey Tail Fan,” the entirety of which is hereby incorporated herein by reference.

### FIELD OF THE DISCLOSURE

The disclosure relates generally to a decoy device and a tail fan device that can be included with the decoy device, and, more particularly, a tail fan device that comprises a collapsible turkey fan device that can be included in or attached to the decoy device or used by itself.

### SUMMARY OF THE DISCLOSURE

A tail fan device is disclosed that can be included with or attached to a decoy device such as a Tom Turkey decoy, or used by itself as a collapsible turkey fan device. The tail fan device can be constructed to be easily removable from or attachable to the decoy device. The tail fan device can be constructed to be collapsible to require less storage space or to allow easier transport.

The tail fan device comprises a holder, a panel support and a plurality of feather panels that can be painted to mimic real turkey feathers. The tail fan device can comprise a fan clip. The holder can be constructed to hold and guide a feather panel in one or more channels as it travels between a fanned-out configuration and a collapsed configuration of the tail fan device. The holder can include a fan-out stop at an end of the channel to stop or position the feather panel in a predetermined position when the tail fan device is in the fanned-out configuration. The holder can include another fan-out stop at the other end of the channel to stop or position the feather panel in a second predetermined position when the tail fan device is in the collapsed configuration. The second predetermined position can be located with respect to the holder such that the feather panel is in a central location and positioned substantially perpendicular to an upper surface of the holder.

The holder can comprise a multi-tier channel configuration having a plurality of channels, each being constructed to hold and guide a feather panel. The channels can be constructed to allow each feather panel to only move a predetermined distance and direction, such that when the feather panels are fully fanned out the tail fan device forms a realistic turkey tail fan.

In a non-limiting embodiment, the tail fan device comprises the holder, the panel support and seven individual feather panels, with each feather panel detailed to mimic eight, nine, or ten actual turkey feathers. Each feather panel has three openings at its bottom end to receive and attach to the panel support. The panel support includes a screw, bolt, rod, or pin. The individual feather panels can be mounted in the holder with the panel support, which can be inserted in an opening on a front or back side of the holder, through one of the three holes in each feather panel and screwed or attached to an opposite back or front side of the holder. The first tier of a pair of feather panels can be rotatably attached to the panel support through the upper-most opening on the panels; the second tier of feather panels can be rotatably attached to the panel support through middle opening on the panels; and, the third tier of feather panels can be rotatably attached to the panel support through the lower-most opening on the panels, thereby creating a tiered panel configuration that realistically mimics a fan tail. The seventh feather panel can be attached directly to the holder and arranged to be stationary. Alternatively, the seventh feather panel can include an opening that is closer to the bottom edge of the panel than the lower-most opening used to mount the third tier of panels. The variation in mounting position creates a natural looking tail fan when the tail fan device is fully fanned-out.

The tail fan device can be constructed to allow manual positioning of the feather panels.

Alternatively, the tail fan device can be constructed to automatically move the feather panels to the fanned-out configuration or collapsed configuration. The tail fan device can comprise an actuator that can be arranged to bias each feather panel to its the fanned-out configuration position or collapsed configuration position.

The holder can be constructed to have any shape or size. The holder can be constricted to have a shape and size that can mate with an attachment mechanism on the decoy device. The holder can be used without the attachment mechanism. The holder can be formed as part of the decoy device. The holder can be attached directly to the decoy device by a fastener, an adhesive, Velcro, or the like. The attachment mechanism can include a recess, a clip, or any other device or structure that can secure the holder to the decoy device. For instance, the attachment mechanism can include a clip that is permanently or removably attached to the decoy device, in which case the holder can be constructed to snap into the clip. The holder can be arranged to be removable from the decoy device so the decoy device can be transported or stored without the tail fan device, or so that the tail fan device can be used without the decoy device.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a front view, of a non-limiting embodiment of a tail fan device 10 that is constructed according to the principles of the disclosure.

FIG. 2 shows a back view of a non-limiting embodiment of a tail fan device 10 that is constructed according to the principles of the disclosure.

FIG. 3 shows a side view of a non-limiting embodiment of a tail fan device 10 that is constructed according to the principles of the disclosure.

FIG. 4 shows a front view of the tail fan device in a collapsed configuration.

FIG. 5 shows a side view of the tail fan device in a collapsed configuration.

FIG. 6 shows a top view of the tail fan device in a collapsed configuration.

FIG. 7 shows a non-limiting embodiment of a feather panel that can be included in the tail fan device.

FIG. 8 shows a front, view of a non-limiting embodiment of a holder that can be included in the tail fan device.

FIG. 9 shows a back view of a non-limiting embodiment of a holder that can be included in the tail fan device.

FIG. 10 shows a top view of a non-limiting embodiment of a holder that can be included in the tail fan device.

FIG. 11 shows a side view of a non-limiting embodiment of a holder that can be included in a tail fan device.

FIG. 12 shows front view of a non-limiting embodiment of a fan clip that can be included with the tail fan device, or used to attach the tail fan device to a decoy device.

FIG. 13. shows a back view of a non-limiting embodiment of a fan clip that can be included with the tail fan device, or used to attach the tail fan device to a decoy device.

FIG. 14 shows a side view of a non-limiting embodiment of a fan clip that can be included with the tail fan device, or used to attach the tail fan device to a decoy device.

FIG. 15 shows a bottom view of a non-limiting embodiment of a fan clip that can be included with the tail fan device, or used to attach the tail fan device to a decoy device.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. The features illustrated in the drawings are not necessarily drawn to scale, and features of one embodiment can be employed with other embodiments as the skilled artisan would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those of skill in the art to practice the embodiments of the disclosure. Accordingly, the examples and embodiments should not be construed as limiting the scope of the disclosure, which is defined solely by the appended claims and applicable law. Moreover, it is noted that like reference numerals represent similar parts throughout the several views of the drawings.

Realistic turkey decoys, such as, for example, certain Tom Turkey decoys, have a fabric or cardboard tail fan that is not realistic looking and very hard to store or transport. Sometimes people have used actual turkey feathers from previously killed turkeys, but these are not collapsible and do not last long since they get beaten up over time. The inventors have discovered a great and unmet need for a collapsible tail fan device that is durable, life-like and can be made with individual or groups of individual feather panels that can be painted to mimic real turkey tail feathers.

The inventors have created a tail fan device that has proven to be so realistic and effective in tests with wild turkeys in the field that the user was able to repeatedly approach the animals within just a few feet by positioning the fanned-out tail fan device between the animal and user, such that the user was obscured from the animal's view by the device.

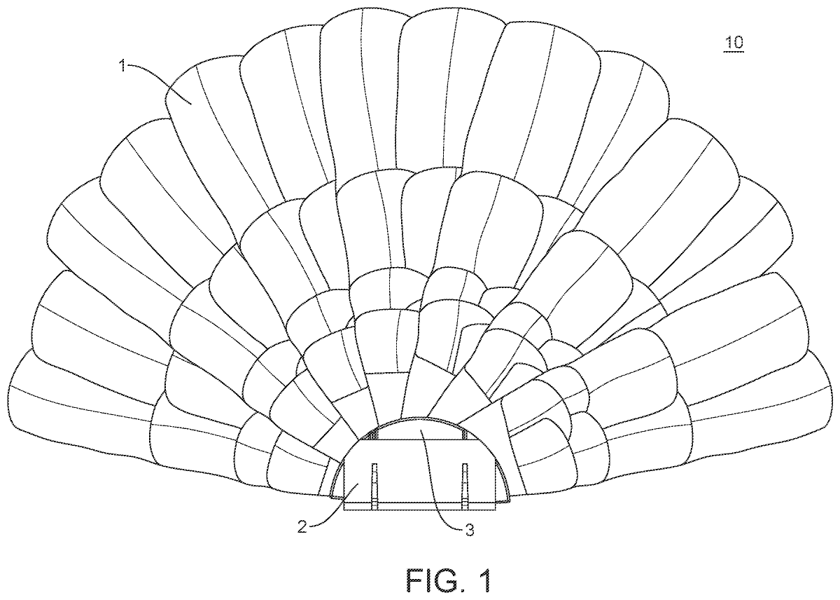

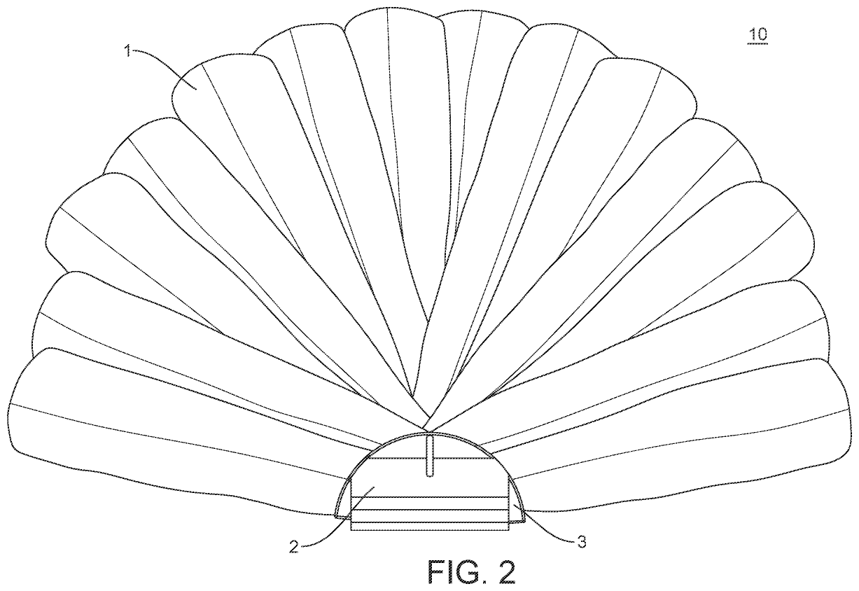

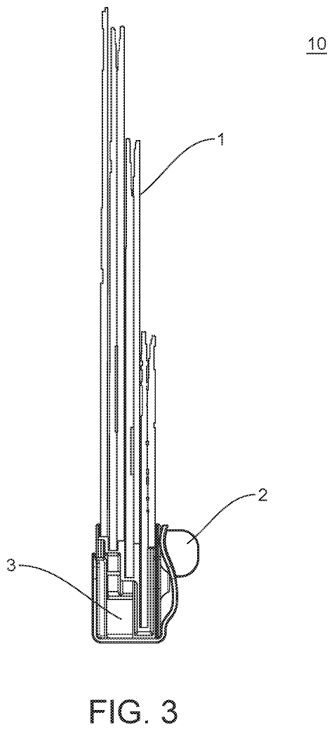

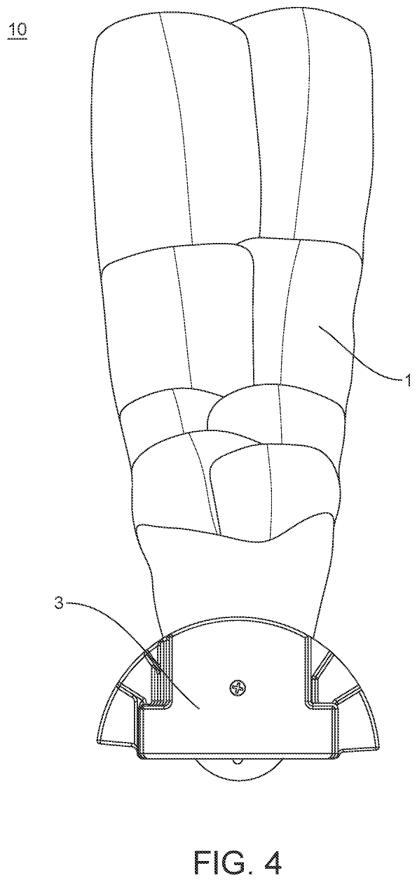

FIGS. 1-3 show front, back and side views, respectively, of a non-limiting embodiment of a tail fan device 10 in a fanned-out configuration. The tail fan device 10 can include a grouping 1 of feather panels and a holder 3. The tail fan device 10 can include or it can be attached to a fan clip 2. The grouping 1 of feather panels can be moved or fanned out to the fanned-out configuration (shown in FIGS. 1 and 2) from a collapsed configuration (shown in FIG. 4), or moved or collapsed to the collapsed configuration from the fanned-out configuration.

FIG. 4 shows a front view of the tail fan device 10 in a collapsed configuration, without the fan clip 2. As seen in this embodiment, the group 1 of feather panels can be collapsed to make the tail fan device 10 smaller, for example, to facilitate storage or shipment.

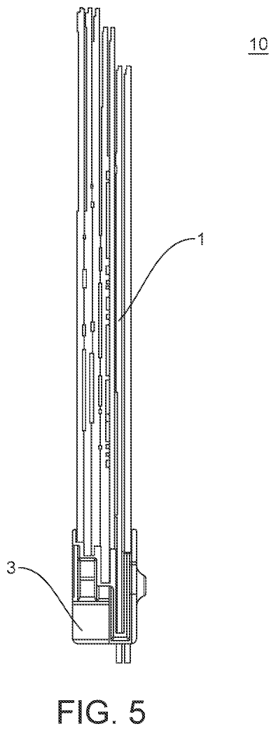

FIG. 5 shows a side view of the tail fan device 10 in the collapsed configuration, without the fan clip 2.

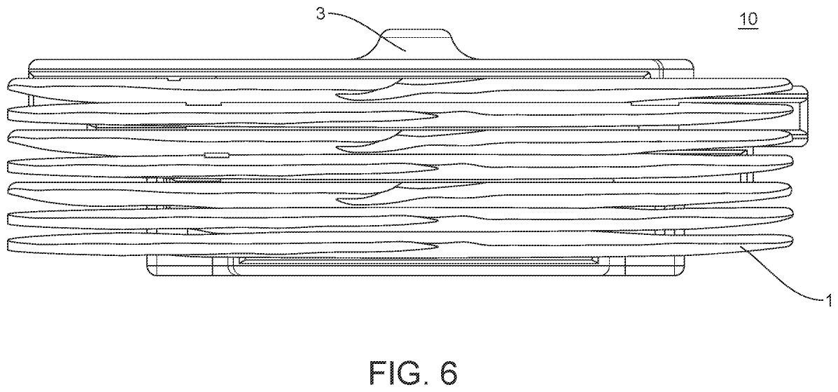

FIG. 6 shows a top view of the tail fan device 10 in the collapsed configuration, without the fan clip 2.

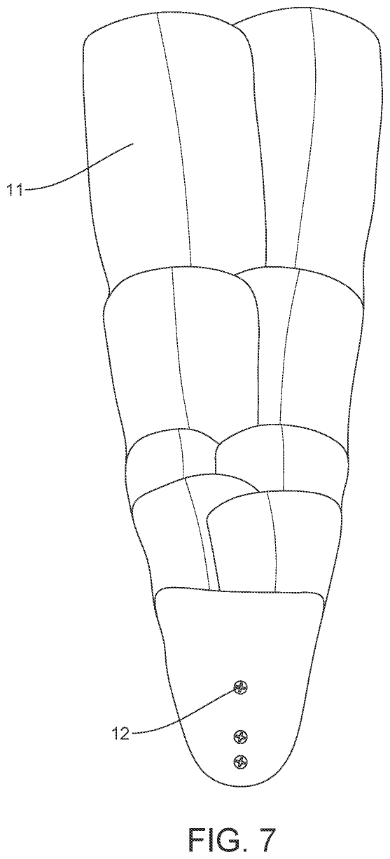

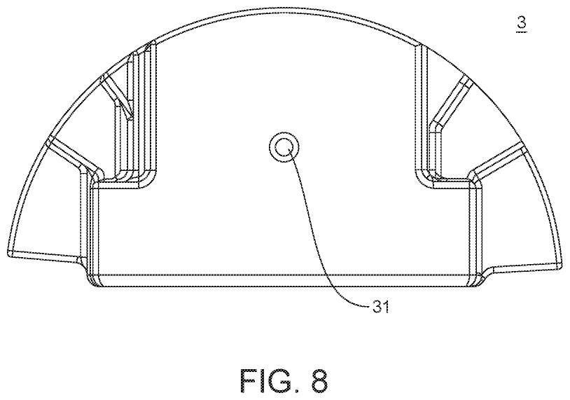

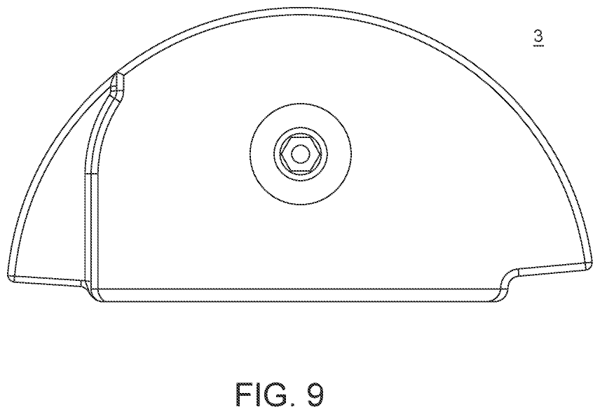

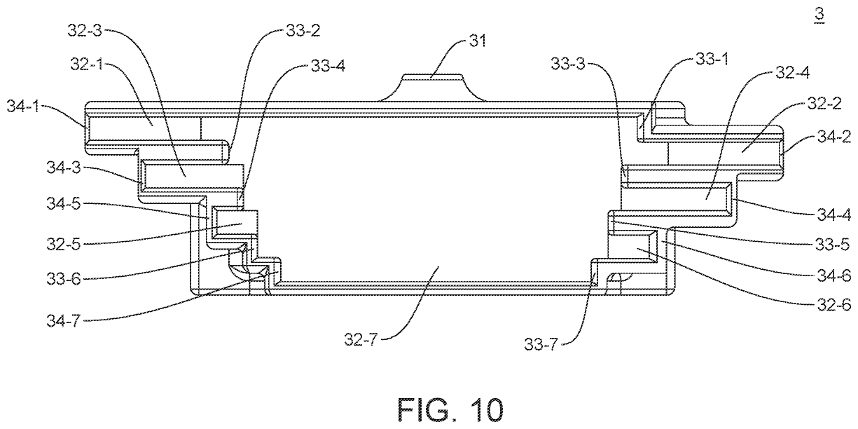

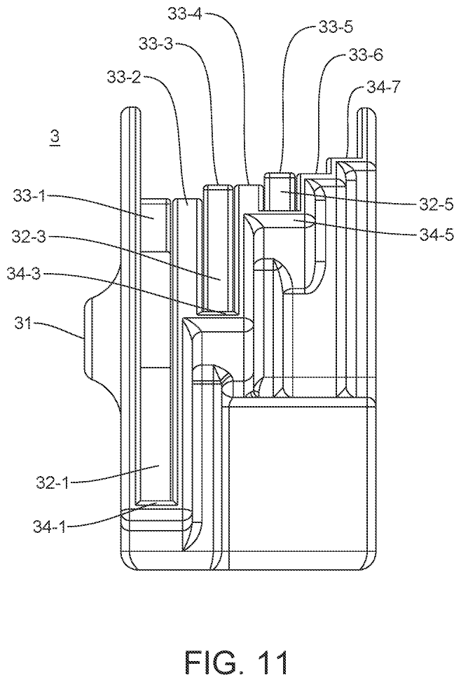

FIG. 7 shows a non-limiting embodiment of a feather panel 11 that can be included in the grouping 1 of feather panels (shown in FIGS. 1-6). The feather panel 11 can include one or more openings 12. In this non-limiting embodiment, the feather panel 11 includes three openings 12, each of which can be located on the feather panel 11 such that it can be aligned with a mount point 31 (shown in FIGS. 8-11) in the holder 3 and mounted on the panel support (not shown), which can include, for example, a screw, bolt, rod or pin. The three openings 12 on each feather panel 12 can allow for the same feather panel 11 to be useable in any of the three separate tiers in the holder 3. For instance, the feather panel 11 that can be located in channel 32-1 (shown in FIGS. 10 and 11) of the holder 3 can be mounted to the panel support (not shown) using the opening 12 that is furthest from a bottom end of the feather panel 11. Whereas the feather panel 11 that can be located in channel 32-6 (shown in FIG. 10) of the holder 3 can be mounted to the panel support through the opening 12 that is closest to the bottom end of the feather panel 11.

In alternative embodiments of the tail fan device 10, the holder can include additional feather panels 11, for example, nine (9), eleven (11), thirteen (13) or more feather panels, or fewer than seven (7) feather panels. In those embodiments, the holder 3 can be constructed to have an equal number of channels 32 (shown in FIGS. 10 and 11). Also, in those embodiments, the feather panel 11 can have a number of openings 12 that is equal to the number of tiers of feather panels 11 in the panel device 10. The number of tiers and, therefore, the number of openings 12 can be determined by, for example, taking the total number of movable or expandable/collapsible feather panels (for example, 6 panels, shown in FIGS. 10 and 11) and dividing the number by 2. As seen in the embodiment depicted in FIGS. 10 and 11, the holder 3 can be constructed to hold three tiers of panels (6 panels/2 panels-per-tier=3 tiers). The seventh, odd-numbered panel can be attached directly to the holder 3 (for example, in channel 32-7, shown in FIG. 10), since it can be fixed and immovable. The tiered arrangement can cause the feather panels 11 to be offset in height with each tier and, as a result, appear life-like and realistic when the tail fan device is transitioned to the fanned-out configuration by spreading the feather panels 11, thereby accurately mimicking a real turkey tail.

FIGS. 8-11 show front, back, top, and side views, respectively, of a non-limiting embodiment of the holder 3. In this embodiment, the holder 3 comprises a multi-tier channel configuration, having three tiers with seven separate channels 32 (32-1 to 32-7). The holder 3 can include an opening 31 to receive the panel support (not shown). Each channel 32 in the holder 3 has a panel-stop 33 (33-1 to 33-7, respectively) at one end and another panel-stop 34 (34-1 to 34-7, respectively) at the other end. The panel-stop 34 can operate to stop and hold each corresponding feather panel 11 in its respective, predetermined fanned-out configuration position. The panel-stop 33 can operate to stop and hold each corresponding feather panel 11 in its respective, predetermined collapsed configuration, which in the illustrated embodiment is a central location on the holder 3 such that all feather panels 11 are arranged vertical and substantially normal to the upper surface of the holder 3. Each channel 32 in the holder 3 can be arranged to hold and guide a feather panel 11 (shown in FIG. 7) as it travels back or forth between the collapsed configuration and the fanned-out configuration of the tail fan device. In this embodiment the panel-stops 33-7 and 34-7 can be located at each end of the channel 32-7 such that the corresponding feather panel 11 remains stationary and positioned substantially normal to the upper surface of the holder 3, as seen in FIG. 1 or 2.

The tail fan device 10 can include an actuator (not shown) that can automatically move the feather panels 11 to the fanned-out configuration or collapsed configuration. The actuator (not shown) can be attached to the holder 3 or the panel support (not shown). The actuator can include a spring-biased mechanism or elastic member that can be attached to each feather panel 11 at one end and the panel support at another end. The actuator can include, for example, a plurality of springs wound around or attached to the panel support and each feather panel such that the springs move each feather panel 11 to its fanned-out configuration position. The actuator (not shown) can be arranged to bias the tail fan device 10 to the fanned-out configuration, in which case the tail fan device 10 can be collapsed by manually moving all the feather panels 11 to toward the center to the collapsed configuration. Since the center-most feather panel, such as, for example, the feather panel 11 positioned in the channel 32-7 (shown in FIG. 10), is stationary, it need not be attached to an actuator.

The tail fan device 10 can include a lock mechanism (not shown), which can be configured to secure the tail fan device 10 in either the collapsed configuration or the fanned-out configuration. The lock mechanism can include, for example, a pin, rod, clamp, clip or any other device that can lock the feather panels 11 in a fixed position with respect to the holder 3.

The holder 3 can be constructed to have any shape or size, including, for example, a shape and size that can mate with an attachment mechanism on a decoy device (not shown), such as, for example, a Tom Turkey decoy. The attachment mechanism can include a recess, a clip, or any other device or structure that can secure the holder 3 to the decoy device. The holder 3 can be arranged to be removable from the decoy device so the decoy device can be transported or stored without the tail fan device, or the tail fan device can be used by itself, without the decoy device.

For instance, the attachment mechanism can include the fan clip 2, which can be permanently attached to the decoy device, and the holder arranged to snap into the fan clip 2.

Alternatively, the fan clip 2 can be included with tail fan device 10, in which case the decoy device would have an attachment mechanism that is arranged to engage and attach to the fan clip 2.

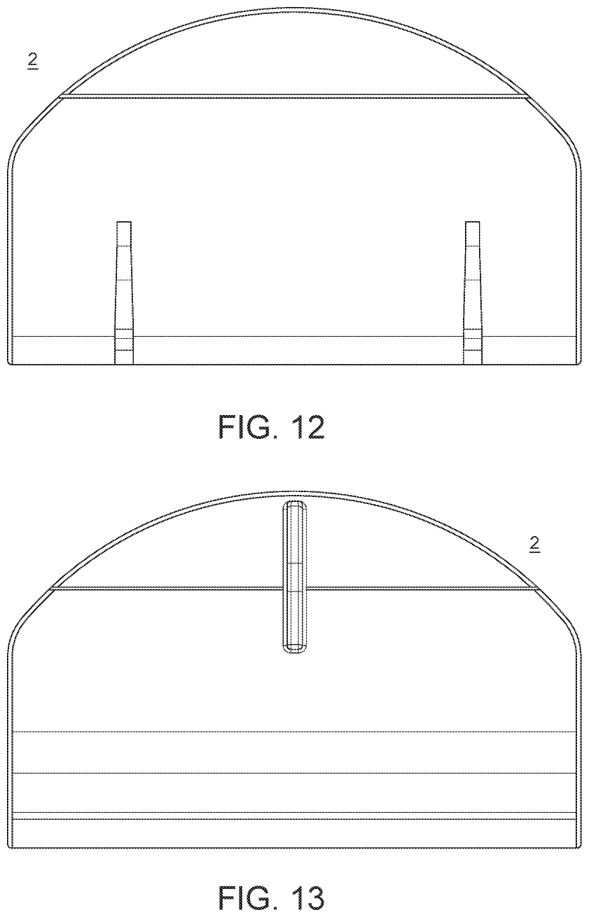

FIG. 12 shows a front view of a non-limiting embodiment of the fan clip 2.

FIG. 13 shows a back view of a non-limiting embodiment of the fan clip 2.

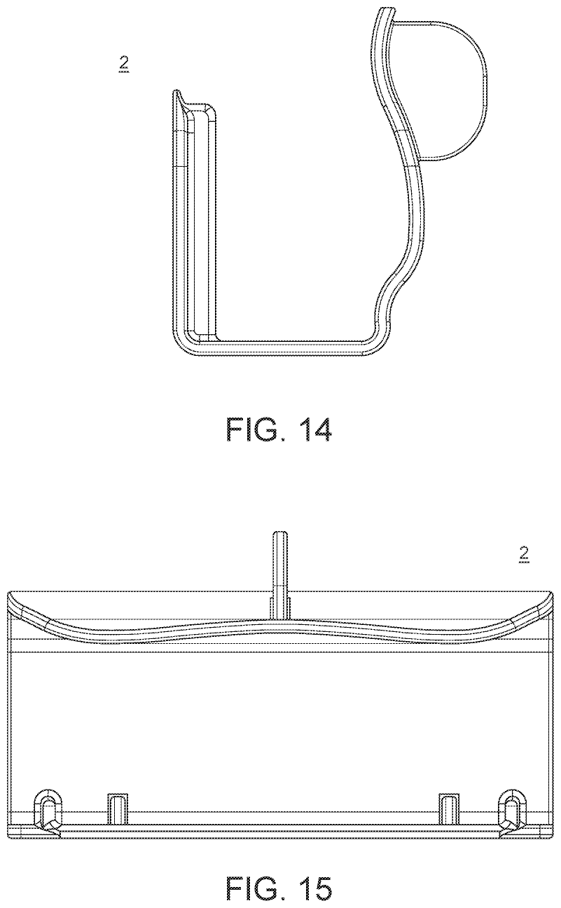

FIG. 14 shows a side view of a non-limiting embodiment of fan clip 2.

FIG. 15 shows a bottom view of a non-limiting embodiment of the fan clip 2.

A multi-tier holder 3, including the non-limiting embodiment depicted in FIGS. 1-3, can be manufactured, for example, as separate components (for example, plates) that can then be assembled to form the holder 3. Alternatively, the multi-tier holder 3 can be formed from raw material, for example, by machining or injection molding. For instance, the multi-tier holder 3 can be formed by machining a block of material (for example, metal, wood, or man-made material) by forming a plurality of channels in the material, each channel being arranged to guide and hold a feather panel; by forming a plurality of panel-stops in the material; and by forming an attachment mechanism arranged to attach to a panel support. The plurality of panel-stops can include a first panel-stop arranged to stop the feather panel in a predetermined collapsed configuration position and a second panel stop arranged to stop and hold the feather panel in a predetermined fanned-out configuration position.

Alternatively, the multi-tier holder 3 can be formed using molding (or injection molding) by making a mold that, when injected with molding material, can form a mold comprising the multi-tier holder 3, for example, as depicted in FIGS. 1-3. The mold can be made by a machining process, similar to that discussed above for machining the raw material, including each of the steps discussed above. However, the machining process for the mold should result in an inverted mold structure that is an inverse of the multi-tier holder 3, such that, when a cavity in the mold body is filled with an injectable material, the multi-tier holder 3 is formed by the mold structure.

Alternatively, the multi-tier holder 3 or mold structure (not shown) can be made using three-dimensional (3-D) printing technologies.

The terms “a,” “an,” and “the,” as used in this disclosure, means “one or more,” unless expressly specified otherwise.

The terms “including,” “comprising,” and variations thereof, as used in this disclosure, mean “including, but not limited to,” unless expressly specified otherwise.

Although process steps, method steps, or the like, may be described in a sequential order, such processes and methods can be configured to work in alternate orders. In other words, any sequence or order of steps that may be described does not necessarily indicate a requirement that the steps be performed in that order. The steps of the processes or methods described herein can be performed in any order practical. Further, some steps can be performed simultaneously.

When a single structure or article is described herein, it will be readily apparent that more than one device or article may be used in place of a single device or article. Similarly, where more than one device or article is described herein, it will be readily apparent that a single structure or article may be used in place of the more than one structure or article. The functionality or the features of a structure or article may be alternatively embodied by one or more other structures or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. A multitier holder, comprising:
a plurality of channels, each channel being arranged to guide and hold a feather panel at one of a plurality of tiers in the holder;
a plurality of panel-stops; and
a part arranged to attach to a panel support,
wherein the plurality of panel-stops include a first panel-stop arranged to stop the feather panel in a predetermined collapsed configuration position and a second panel stop arranged to stop and hold the feather panel in a predetermined fanned-out configuration position.

2. The multitier holder in claim 1, wherein the plurality of channels comprises seven channels, each arranged to guide and hold a corresponding feather panel.

3. The multitier holder in claim 1, further comprising the panel support, wherein the panel support comprises a bolt.

4. The multitier holder in claim 3, wherein said part comprises a nut arranged to attach to the bolt.

5. A tail fan device, comprising:
a holder having a plurality of panel-stops and a plurality of channels, each channel being constructed to guide and hold a feather panel at one of a plurality of tiers; and
a grouping of feather panels painted as realistic turkey tail feathers,
wherein the plurality of panel-stops include a first panel-stop arranged to stop the feather panel in a predetermined collapsed configuration position and a second panel stop arranged to stop and hold the feather panel in a predetermined fanned-out configuration position.

6. The tail fan device in claim 5, further comprising:
a panel support constructed to attach to the holder and a plurality of feather panels in the grouping of feather panels, wherein the panel support is arranged to rotatably support the plurality of feather panels.

7. The tail fan device in claim 6, further comprising:
an actuator constructed to automatically rotate each of the plurality of feather panels around the panel support.

8. The tail fan device in claim 7, wherein the actuator comprises a spring or elastic member that biases each of the plurality of feather panels to a unique fanned-out configuration position.

9. The tail fan device in claim 8, wherein each fanned-out configuration position is determined by one of the plurality of panel-stops.

10. The tail fan device in claim 6, wherein each of the plurality of channels is constructed to guide a unique one of the plurality of feather panels as it moves between a collapsed configuration position and a fanned-out configuration position.

11. The tail fan device in claim 10, wherein the fanned-out configuration position is determined by one of the plurality of panel-stops and the collapsed configuration position is determined another one of the plurality of panel-stops.

12. The tail fan device in claim 5, further comprising a fan clip attached to the holder.

13. The tail fan device in claim 5, wherein the tail fan device is adapted to attach to a turkey decoy device.

14. The tail fan device in claim 5, wherein the plurality of channels comprises seven channels, each arranged to guide and hold a corresponding feather panel.

15. The tail fan device in claim 5, further comprising a panel support, wherein the panel support comprises a bolt.

16. The tail fan device in claim 15, wherein the holder comprises a nut arranged to attach to the bolt.

17. A turkey decoy device comprising the multitier holder in claim 1.

18. A method of manufacturing a multitier holder for a turkey fan device, the method comprising:
forming a plurality of channels in a material, each channel being arranged to guide and hold a feather panel;
forming a plurality of panel-stops in the material; and
forming an attachment mechanism arranged to attach to a panel support,
wherein the plurality of panel-stops include a first panel-stop arranged to stop the feather panel in a predetermined collapsed configuration position and a second panel stop arranged to stop and hold the feather panel in a predetermined fanned-out configuration position.

19. The method in claim 18, wherein the forming the plurality of channels comprises machining a plurality of channels in the material.

20. The method in claim 18, wherein the forming the plurality of channels comprises molding the material with a plurality of channels in the material.
